(19) United States
(12) Patent Application Publication
(10) Pub. No.: US 2015/0242036 A1
(43) Pub. Date: Aug. 27, 2015

(54) SYSTEM AND METHOD FOR DETECTING TAPS ON A SURFACE OR ON A DEVICE

(71) Applicants: Amin Heidari, North York (CA); Tusi Chowdhury, Toronto (CA); Parham Aarabi, Toronto (CA)

(72) Inventors: Amin Heidari, North York (CA); Tusi Chowdhury, Toronto (CA); Parham Aarabi, Toronto (CA)

(21) Appl. No.: 14/186,523

(22) Filed: Feb. 21, 2014

(51) Int. Cl. G06F 3/041; G06F 3/0346

(52) U.S. Cl. CPC G06F 3/0414; G06F 3/0346

(57) ABSTRACT

A system for detecting taps on a surface or on a device, the system comprising at least one module configured to detect one or more taps by receiving signals from one or more sensors; at least one module configured to process signals related to the one or more taps to determine a set of temporal and spatial signal characteristics; at least one module configured to map signals related to the one or more taps to associate the one or more taps with one or more application controls; and at least one module configured to classify signals related to the one or more taps to determine whether the one or more taps are associated with the one or more application controls.

### FIELD OF THE INVENTION

This invention relates generally to event detection systems, and more particularly to systems and methods for detecting physical tap events that may occur on a device or on surfaces adjacent to the device.

### BACKGROUND OF THE INVENTION

There exists several signal analysis and machine learning techniques that solve related tap localization problems [2, 3, 4, 5].

Some approaches apply multiple sensors, and some use more sensitive piezoelectric sensors. [2] applied cross-correlation combined with a weighted averaging of training locations, and a thresholding method, to interpolate discrete tap locations using a Knowles accelerometer.

The algorithm used in [2] yielded good results, but was sensitive to spatial distribution of training locations. The threshold approach also required a pre-determined value, which may vary between surfaces and tap types, leading to a lower detection rate. [2] also attempted to use a forward and backward propagation neural network with radial basis function to predict the tap location given the acoustic signal.

However, [2] found the calibration to not be reliable if the device placement changed relative to the boundaries of the surface, leading to either lengthy calibration phase or poor detection, as well as over-fitting of the data. As a second approach, [2] tried a reverse algorithm where they trained the network to generate the corresponding waveform given a (x, y) coordinate, which would essentially enable [2] to generate pseudo training data that was consistent. [2] did not complete their neural network investigation due to lack of expertise in the field and time constraints.

[3] explored few techniques such as time delay of arrival (TDOA) and cross-correlation to implement an acoustic tap tracker with multiple sensors (Polyvinylidene fluoride (PVDF) sensors) combined with signal amplification. The algorithm applied a weighting and thresholding method on the differences in cross-correlation peaks between the sensors, calibrated using template signals. The implementation yielded good result for low frequency knuckle tap, but performed poorly on hard taps, and taps located closer than 10 cm apart.

[6] applied a similar time differential approximation and spectral analysis to detect knuckle, fist bang and metal tap contact on glass surface by mounting four sensors on four corners behind the tappable surface. The performance was degraded by strong dispersion affect in glass, and non-tap generated acoustic background sound, however [6] yielded good enough results to build store front graphical display interface using knock tap detection.

A project called TAI-CHI [4] explored various tangible acoustic interface solution with application to Human Computer interaction such as electro-acoustic musical instruments, large-scale displays and so on [2]. The majority of the approaches investigated as part of TAI-CHI used time reversal, acoustic holography, combination of audio and visual detection and tracking, and time delay of arrival techniques with multiple sensors [7, 5], which cannot be used with a single sensor approach. However, [4] laid down important foundation to future research opportunities to develop novel touch based user applications. In general, acoustic localization has been extensively studied in literature to solve for multiple sensors sound-localization, utilizing time-reversal and time delay of arrival technique, often augmented by various filtering, probabilistic model, and speech enhancement algorithms [8, 9, 10, 7].

However, a sensor-solution requiring less sensors required for acoustic localization is more desirable for developing software solutions for most portable electronic devices due to limited power, memory or sensors availability.

There have also been several security related research that studied the inference of keystrokes from a nearby keyboard using accelerometer and acoustic sensors [11, 12, 13]. The inference of keystrokes was achieved by using accelerometer recordings corresponding to key press events from an Apple wireless keyboard placed 2 cm away from the phone in [12].

A neural network was trained using features such as mean, max, min, FFT, MFCC from accelerometer. However, due to the limited operational frequency of iPhone accelerometer, which is 100 Hz, the neural net only achieved a detection rate of 25.89%. The second approach used the same feature vector along with relative position of subsequent pairwise key-presses, trained with 150 key strokes per letter at random order and timing-constituting of 3900 distinct events, combined with word matching. This resulted in slightly better performance but varied between 91% to 65% detection rate depending on the left/right or far/near positions and the size of the data set.

The same problem was solved in [14] by using acoustic data to train a neural network, where a PC microphone was used to listen to key-stroke events sampled at 44.1 kHz. The FFT of the acoustic sample was used together with pairwise key pressing event to train the neural net with 100 key press samples per key. [14] managed to achieve a detection rate of 79% with the acoustic feature vector with the same amount of training.

[11] improved upon the performance achieved by [14] by using cepstrum instead of FFT as feature vector together with unsupervised learning using Mixture of Gaussian estimation. The algorithm also incorporated a probabilistic model that biased the prediction based on the prior key detection event using Hidden Markov model, augmented by a language model to further improve the accuracy. These investigations while being reasonably successful, require a large training phase—training of a neural net with precise knowledge of relative key positioning of various key-boards, or clustering simulation using mixture of Gaussian Estimation.

Moreover, the performance degrades with distance and duration of detection. A solution that requires a significant training phase cannot be applied to the problem of detecting taps on a surface within the context of a portable user application, as the algorithm needs to calibrate quickly to the new surface so that the client application can start using the detection software.

Transforming ordinary surfaces into an input medium for digital devices enables more convenient alternatives to currently available touch interfaces. The concept behind tap detection is such a technology, where once a portable device is placed on any surface, the surface becomes tap sensitive. Currently available smartphones have various built-in sensors with capabilities to understand and respond to their surroundings, yet the currently available methods of interacting with the smartphone through the touchscreen is limiting. The possibility of extending the usable interface to include an adjacent surface or parts of the device where there otherwise is no interface may lead to an expanded set of options for interacting with a device.

A new solution is thus needed for to overcome the shortfalls of the prior art.

### REFERENCES

[1] “Extended touch: New apl technology makes any surface touch-sensitive by just placing a mobile device on it”.
[2] Seth Pollen and Nathan Radtke, “Experiments in single-sensor acoustic localization,” Tech. Rep., Research Project, Milwaukee School of Engineering, 2011.
[3] Nisha Checka, “A system for tracking and characterizing acoustic impacts on large interactive surfaces,” M. S. thesis, Electrical and Computer Engineering, MIT, 2001.
[4] Alain Crevoisier and Cdric Bornand, “Tai-chi: Tangible acoustic interface,” 2004-2006, Research on Tangible acoustic interface.
[5] Alain Crevoisier and Pietro Polotti, “Tangible acoustic interfaces and their applications for the design of new musical instruments,” 8th International Conference on Digital Audio Effects, 2005.
[6] Joseph A Paradiso, Che King Leo, Nisha Checka, and Kaijen Hsiao, “Passive acoustic sensing for tracking knocks atop large interactive displays,” CHI 2002 Extended Abstracts on Human Factors in Computing Systems, 2002.
[7] Pietro Polott, Manuel Sampietro, Augusto Sarti, Stefano Tubaro, and Alain Crevoisier, “Acoustic localization of tactile interactions for the development of novel tangible interfaces,” 8th International Conference on Digital Audio Effects, 2005.
[8] Parham Aarabi and Guangji Shi, “Phase-based dual-microphone robust speech enhancement,” IEEE Transactions on Systems, Man, and Cybernetics, 2004.
[9] Parham Aarabi and Safwat Zaky, “Iterative spatial probability based sound localization,” Proc. 4th World Multiconference Circuits, Systems, Computers, Communications, 2000.
[10] Mathias Fink, “Time reversal of ultrasonic fields-part i: Basic principles,” IEEE Transactions on ultrasonic, ferroelectrics, and frequency control, 1992.
[11] Li Zhuang, Feng Zhou, and J. D. Tygar, “Keyboard acoustic emanations revisited,” ACM Transactions on Information and Systems Security, 2005.
[12] Philip Marquardt, Arunabh Verma, Henry Carter, and Patrick Traynor, “Decoding vibrations from nearby keyboards using mobile phone accelerometers,” In Proceedings of the 18th ACM conference on Computer and communications security, 2011.
[13] Zhi Xu, Kun Bai, and Sencun Zhu, “Taplogger: Inferring user inputs on smartphone touchscreens using on-board motion sensors,” Fifth ACM Conference on Security and Privacy in Wireless and Mobile Networks, 2004.
[14] Dmitri Asonov and Rakesh Agrawal, “Keyboard acoustic emanations,” In Proceedings of the IEEE Symposium on Security and Privacy, 2004.
[15] Alain Crevoisier and Pietro Polotti, “A new musical interface using acoustic tap tracking,” Tech. Rep., Universitat Pompeu Fabra (UPF), Barcelona, Spain, 2001.
[16] Thomas H. Heaton, “Surface waves, chapter 5,” lecture notes, California Institute of Technology.
[17] Steven Errede, “Waves and wave propagation,” Tech. Rep., 2002-2012.
[18] John Allen and David Berkley, “Image method for efficiently simulating small-room acoustics,” Journal of the Acoustical Society of America, 1979.
[19] Alain Crevoisier and Cedric Bornand, “Transforming daily life objects into tactile interface,” EuroSSC '08 Proceedings of the 3rd European Conference on Smart Sensing and Context, 2001.
[20] Mathias Fink and Claire Prada, “Acoustic time reversal mirror,” Inverse Problems, 2001.
[21] Christos Tsakostas, “Image receiver model: An efficient variation of the image source model for the case of multiple sound sources and a single receiver,” Tech. Rep., Holistiks Engineering Systems, 2004.
[22] “iphone microphone frequency response comparison,” Tech. Rep., Faber Acoustical LLG, 2009.
[23] Daniel P, “iphone 5 microphone specifications,” Tech. Rep., Phone Arena, 2012.
[24] Mari Ervasti1, Shideh Dashti2, Jack Reilly, Jonathan D. Bray3, Alexandre Bayen3, and Steven Glaser, “ishake: Mobile phones as seismic sensors—user study findings,” In Proceedings of the 10th International Conference on Mobile and Ubiquitous Multimedia, 2011
[25] Melissa J. B. Rogers, Kenneth Hrovat, and Kevin McPherson, “Accelerometer data analysis and presentation techniques,” Tech. Rep., NASA Lewis Research Center, Cleveland, Ohio, 1997.
[26] Mari Ervasti1, Shideh Dashti2, Jack Reilly, Jonathan D. Bray3, Alexandre Bayen3, and Steven Glaser, “ishake: Using personal devices to deliver rapid semi-qualitative earthquake shaking information,” Tech. Rep., U C Berkeley, 2011.
[27] Lindsey Gregor and Jennie Sadler, “Gyroscope and accelerometer,” Tech. Rep., Smith College, 2012, Research Slides, Smith College.
[28] Richard Zernel, “Introduction to machine learning, lecture 3: Classification,” Tech. Rep., 2012, Lecture notes for CSC2515.
[29] Tusi Chowdhury, Parham Aarabi, Weijian Zhou, Yuan Zhonglin, Kai Zou, and Bill Liu, “Extended touch surface,” IEEE International Conference on Multimedia and Expo, 2013.
[30] Tusi Chowdhury, Parham Aarabi, Weijian Zhou, Yuan Zhonglin, Kai Zou, and Bill Liu, “Extended touch mobile interfaces through sensor fusion,” The 16th International Conference on Information Fusion, 2013.

### SUMMARY OF THE INVENTION

The present disclosure relates to a system and method for detecting one or more physical taps both on the device and on surfaces adjacent to the device.

In accordance with an embodiment of the invention, a system for detecting one or more taps on a surface or on a device is provided, the system comprising:
a. at least one module configured to detect one or more taps by receiving signals from one or more sensors;
b. at least one module configured to process signals related to the one or more taps to determine a set of temporal and spatial signal characteristics;
c. at least one module configured to map signals related to the one or more taps to associate the one or more taps with one or more application controls; and
d. at least one module configured to classify signals related to the one or more taps to determine whether the one or more taps are associated with the one or more application controls.

In accordance with an embodiment of the invention, the system further comprises at least one module configured to reduce noise.

In accordance with an embodiment of the invention, the at least one module configured to map signals related to the one or more taps to associate the one or more taps with one or more application controls uses a plurality of taps to associate the taps with the one or more application controls.

In accordance with an embodiment of the invention, the at least one module configured to map signals related to the one or more taps to associate the taps with one or more application controls combines the plurality of taps to develop a single representative template for associating the one or more taps with the one or more application controls.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

In the drawings, embodiments of the invention are illustrated by way of example. It is to be expressly understood that the description and drawings are only for the purpose of illustration and as an aid to understanding, and are not intended as a definition of the limits of the invention.

FIG. 1 illustrates an exemplary representative generic implementation of the invention.

FIG. 2 is a perspective view of a device on a table, according to one aspect of the invention.

FIG. 3 is a block schematic diagram of the system, according to at least one aspect of the invention.

FIG. 4 is a sample graph illustrating the impulse response on a microphone corresponding to a tap event on a surface, according to at least one aspect of the invention.

FIG. 5 is a sample graph illustrating the point of maximum cross-correlation values received by a microphone with a tap at (20,0), compared to template taps at various locations, according to at least one aspect of the invention.

FIGS. 6 (a) and (b) are sample graphs illustrating the impulse response on a accelerometer in the x-axis to a tap event on a surface, (a) corresponding to a soft tap, and (b) corresponding to a knock tap, according to at least one aspect of the invention.

FIGS. 7 (a) and (b) are sample graphs illustrating the impulse response on a accelerometer corresponding in the z-axis to a tap event on a surface, (a) corresponding to a soft tap, and (b) corresponding to a knock tap, according to at least one aspect of the invention.

FIG. 8 is a sample graph illustrating the point of maximum cross-correlation values received by a accelerometer measuring in the z-axis with a knuckle tap on glass at (20,0), compared to template taps at various locations, according to at least one aspect of the invention.

FIGS. 9 (a), (b) and (c) are sample graphs illustrating the impulse response on a gyroscope corresponding (a) in the x-axis, (b) in the y-axis, and (c) in the z-axis, according to at least one aspect of the invention.

FIG. 10 is a top view perspective diagram of the device laid out on a surface, according to at least one aspect of the invention.

FIG. 11 (a)-(f) illustrate sample configurations for conducting detecting taps on the system using two template points, according to at least one aspect of the invention.

FIGS. 12 (a) and (b) are sample graphs illustrating error rates after a number of taps were detected and classified.

FIG. 13 is a sample graph comparing the classification rate of success to the number of templates per location, according to at least one aspect of the invention.

FIGS. 14. (a) and (b) are sample graphs illustrating the impulse responses from (a) a microphone, and (b) an accelerometer in the z-axis, according to at least one aspect of the invention.

### DETAILED DESCRIPTION

The present invention, in some embodiments, provides a system for detecting taps either on a device or on one or more surfaces adjacent to the device.

Tap detection technology may potentially convert everyday surfaces into user interfaces for use with a device.

For example, when a tap happens on a table surface, the vibration generated from the tap reaches the device and is read using the accelerometer, gyroscope and microphone.

Given an understanding of wave propagation in surfaces generated due to a tap event, combined with the knowledge of existing sound localization techniques and prior research on related tap or vibration detection, taps from different locations generate different impulse responses due to variable distance travelled, reflections, scattering and dispersion in the medium, and boundary conditions of the surface. The impulse response captured by these acoustic and piezoelectric sensors is studied to extract feature sets that best represent the wave propagation, and differentiates signals from different locations, allowing for tap localization without the prior knowledge of surface parameters.

In an embodiment of the invention, a system for detecting taps may involve two steps: first, training the system in a “training mode” by providing a set of template at each location that is defined for each distinct control element, and second, when a new tap is detected, to process this tap and determine whether the new tap is closely associated with a location linked to a control element during training (“classification”).

This association may be determined through by analyzing the temporal and spectral features of the taps to determine the maximum cross-correlation between them, and selecting the highest value. Other analytical methods may also be used to detect or to refine the classification between taps and templates. Further, in some embodiments of the invention, the system may also determine that a tap is not associated with a template tap and is a new, unclassified tap.

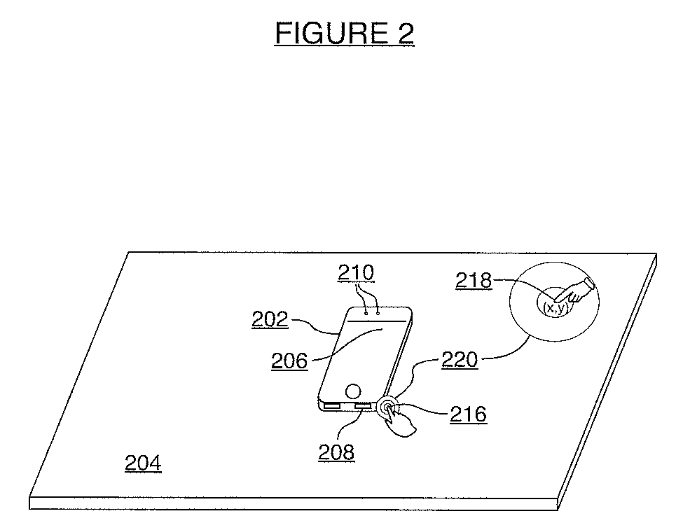

Referring now to FIG. 2, a perspective view of a device on a table, according to one aspect of the invention.

A device 202 is adjacent to a surface 204. The device 202 may be subject to one or more tap events 216. The surface 204 may be subject to one or more tap events 218. The one or more tap events 216 and 218 cause one or more vibration signals 220 to be transmitted to the device 202.

The device 202, as illustrated in this embodiment, is a mobile device, with one or more accelerometers 206, one or more microphones 208, one or more other sensors 210, and one or more processors. The one or more accelerometers 206, the one or more microphones 208 and the one or more other sensors 210 are collectively referred to as the “sensors” on device 202. An increased number of sensors may result in more information being captured, the information which may be analyzed independently or in conjunction to provide more accuracy or faster performance.

The one or more other sensors 210 may include sensors such as proximity sensors, gyroscopes, near-field communications sensors, ambient light sensors, force sensors, location sensors, cameras, radio-frequency identification sensors, humidity sensors, temperature sensors, capacitive sensors, resistive sensors, and surface acoustic wave sensors, among others. These other sensors 210 may be used in conjunction with the accelerometers 206 or microphones 208 to detect or classify taps.

The sensors may be of various models, makes and functionalities. For example, the microphones on mobile devices vary in model, specifications and in quantity between generations and particular brands. On the iPhone 4 and iPad, there are two microphones—and are known to have a sharp cutoff in frequency response at ˜20 kHz. On iPhone 5, there are three microphones that support HD Voice—one in front and back near the camera, and one at the bottom—have double the frequency and spectrum width as of the previous models. The extra microphones may be used for noise cancellation, and are not accessible as separate audio units. In this example, high quality, low latency audio input may be obtained by sampling at the recommended rate of 44.1 kHz.

In alternative embodiments of the invention, the information gathered by the one or more sensors would be available for signal processing. For example, on the camera, the amount of brightness on different sides of the camera's field of view might change depending on the radial location of the tap. Another example would be that the location sensor on the device 202 may provide information for the system 200 to determine that it should use a set of templates associated with an application (e.g. the device realizes that it is on a nightstand).

A device 202 may include, in this embodiment, any available mobile device including (but not limited to) iPhone 4, 5, Google Nexus, Samsung Galaxy devices and Windows, Android, and iOS operating systems.

The device 202 contains instructions for a system 200 stored on one or more non-transitory computer-readable storage media that may be executed on the one or more processors to detect and classify tap events 216 and 218.

In alternate embodiments, the device 200 is not limited to a mobile device but rather may be any hardware that has at least:
One acoustic sensor (e.g. a microphone)
Processing power sufficient to receive and process the digital time-domain signals collected from the sensor(s).

In alternate embodiments, the device 200 may also have other sets of sensors, such as motion sensors to sense linear and angular vibrations (e.g. an accelerometer). However, the acoustic signature is fully sufficient for the tap detection/classification. The data from other types of motion/rotation sensors may be helpful in providing additional information.

The processors require sufficient processing power to execute a number of steps, which requires a minimum number of processor cycles to detect and classify tap events 216 and 218. Reduced processing power may increase the time required to detect and classify tap events 216 and 218, but it will not negate the ability to detect and classify tap events 216 and 218.

In an embodiment of the invention, other types of hardware having the listed minimum requirements may be used with the system and method for detecting taps. Example devices may include a sufficiently enabled computer, tablet computer, laptop, monitor, microwave, home appliances, military appliances, etc.

The surface 204 may be any surface adjacent to the device where vibration signals 200 generated by tap events 218 through the surface could be detected by at least one of the sensors on the device 202. Examples of types of surfaces includes any type of hard surface materials including (but not limited to) glass, metal, wood, kitchen counter, porcelain, etc.

The system 200 may also detect tap events 216 anywhere on a device 202 (e.g. the front, the top, the bezel, the rear, the sides of the device) where vibration signals 220 can be transmitted to the sensors.

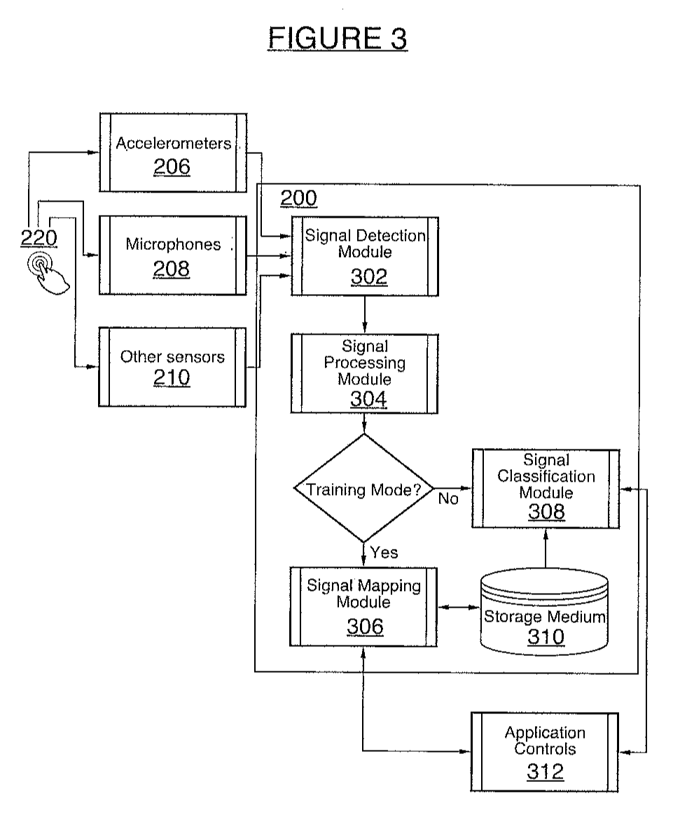

Referring now to FIG. 3, a block schematic diagram of the system is provided, according to an embodiment of the invention.

The system 200 comprises at least one signal detection module 302, at least one signal processing module 304, at least one signal mapping module 306, at least one signal classification module 308, and at least one storage medium 310. The at least one signal mapping module 306 and the at least one signal classification module 308 are linked to at least one application controls 312.

In an embodiment of the invention, the system 200 further comprises at least one noise cancellation module.

Tap events 216 and 218 are transmitted through the device 202 or through the surface 204 by way of vibration signals 220 to the sensors. The information from the sensors is transmitted to the signal detection module 302.

The signal detection module 302 monitors the sensors for incoming signals, which may include ambient noise and movement, or non-tap related noise and movement.

In an embodiment of the invention, the signal detection module 302 is configured to determine that a tap event has occurred when the accelerometers 206 detect an amplitude past a pre-set threshold. If the accelerometers 206 detect an amplitude past a pre-set threshold, the event may be indicative of a tap event, and the data from the microphones 208 is sampled around the duration of the tap event to receive vibration signals 220.

Alternative embodiments of the invention exist where determining if a tap event has occurred where the information collected from the sensors is used in a different order or through a different method.

Depending on the application, the sensors may be set to be ‘always on’ and continuously receiving and analyzing signals, or may be ‘turned on’ when needed by an application.

In an embodiment of the invention, if the device 202 is playing sounds or vibrating, the detection algorithms will adjust for these vibrations in determining whether there has been a tap and will also adjust when processing the vibration signals for their temporal and spectral features. For example, the signal detection module 302 may apply a filter to adjust for the device 202 playing sounds or vibrating.

If a tap event is considered to have occurred, the signal detection module 302 communicates the time-domain signals to the signal processing module 304. The time-domain signals may be in analog or digital forms.

The signal processing module 304 extracts temporal and spectral features from the time-domain signals from the sensors.

The temporal and spectral features include, but are not limited to, amplitude, frequency, duration, energy, auto-correlation, cross-correlation, zero-crossings.

The spectral frequency characteristics may be extracted and/or analyzed using various signal processing techniques, such as a Laplace transformation, Z-transformation, Fourier transformation, a Fast-Fourier transformation, cepstrum, Gaussian estimation, Hidden Markov models, logistic regressions.

In some embodiments of the invention, signals may be pre-processed, filtered, or time adjusted (potentially using onset-based or cross-correlation) prior to extraction.

In some embodiments of the invention, other signal processing techniques may be used such as wavelet transformations.

The signal processing module 304 has a ‘regular mode’ and a ‘training mode’.

The ‘training mode’ is set when the application controls 312 are being mapped to associate taps at particular locations to particular controls. One or more template taps would have to be stored in storage medium 310 for each of the particular locations. For example, a tap on the left side of the table could be associated with flipping a page in a leftward direction in an application.

The regular mode is set when tap events received are to be classified to determine whether they are associated with any of the particular locations associated with the application controls 312. For example, when an unknown is tap is received and determined to be a tap to a table to the left side of the table, which then would trigger the flip of the page in a leftward direction in an application.

In an alternate embodiment, the application controls 312 include controls to control an interface at an operating system level (e.g. to provide a command to the device itself, as opposed to an application residing on the device).

In an embodiment of the invention, the signal processing module 304 is able to distinguish between taps on the device and taps on a surface adjacent to the device.

Alternative embodiments to the invention exist where different algorithms used to process the vibration signal extract different combinations and permutations of temporal and spectral features.

### Training Mode

If the signal processing module 304 is set to a ‘training mode’, the temporal and spectral features of the tap event is transmitted to a signal mapping module 306.

The signal mapping module 306 associates the temporal and spectral features of the tap event with a particular control in an application and stores the temporal and spectral features as a template tap event. Multiple templates may be stored for each control, and an algorithm may be used to determine elements correlated between templates for a single control to improve accuracy and consistency. A greater number of templates may lead to higher accuracy, depending on the surface involved and the type of tap. However, a great number of templates may also lead to a larger amount of processing power required and lag time when classifying the taps.

In an embodiment of the invention, more than one (e.g. 5) templates can be taken for each tap location in the training mode.

In an embodiment of the invention, to increase accuracy, individual templates mapped to an individual control may be analyzed and combined into a single, representative template for that individual control. For example, 5 templates are taken for a control that is associated with flipping a page left. Rather than comparing a new tap against all 5 reference templates, a representative template is made from the common spectral and temporal elements extracted from the 5 templates. A new tap would then be compared against this one representative template to reduce processing time and complexity.

Various embodiments of the invention exist where different algorithms may use different ranges of those signals depending on their structure and optimization/processing methods.

### Regular Mode

If the signal processing module 304 is set on a ‘regular mode’, the temporal and spectral features of the tap event are transmitted to a signal classification module 308.

The signal classification module 308 is configured to classify a tap event as being associated with a particular control available on an application on the device.

In an embodiment of the invention, the association is determined through computing a similarity measure between that tap and all available template taps.

Example algorithms for associating taps may be, but are not limited to, analyses of correlation between signals using binary nearest neighbor algorithms and k-nearest neighbor algorithms.

The temporal and spectral elements that are extracted and used to identify/classify signals may be a number of signal characteristics. A skilled reader would understand that these characteristics may include a number of different signal objects such as impulses, frequency-modulated signals, amplitude-modulated signals, in either continuous time or discrete time.

In further embodiment of the invention, the association is determined through computing the maximum cross-correlation between that tap and all available template taps, and selecting the highest template with the highest cross-correlation value, after a cross-correlation value threshold has been reached.

In another embodiment of the invention, the system 200 may instead be configured to determine that a tap is not associated with any controls and instead classifies the tap as a new tap. In a further embodiment, it may create a new classification group for this tap and use it in comparing against future, unknown taps for associations.

If a match is found to a template tap associated with a particular control, the signal classification module 308 communicates to the application controls 312 that a particular control was accessed.

Using a photo gallery application as an example, through training, a tap on the left side of the table may be associated with browsing left, and a tap on the right side of the table may be associated with browsing right. After training, the left side of the table is tapped to activate the browsing left control.

As the system 200 does not have prior knowledge of which side of the table was tapped, the signal classification module 308 would compare the processed temporal and spectral features of the tap with stored templates to determine whether the tap is more similar to the trained tap on the left side of the table, or the trained right side of the table. The signal classification module 308 would then communicate to the photo gallery application that a tap indicating browsing left was executed.

The noise cancellation module is configured to apply noise cancellation/filtering techniques to improve the signal-to-noise ratio of the signals collected from the sensors. Examples of cancellation/filtering techniques include (but are not limited to) spectral filters (with passband and stopband determined by the nature of the noise and signal), Butterworth filters, Chebyshev filters, Bessel filters, Elliptic filters, Gaussian filters, etc.

In an embodiment, adaptive filters that self-adjust their transfer functions to reduce noise may also be used to improve the signal to noise.

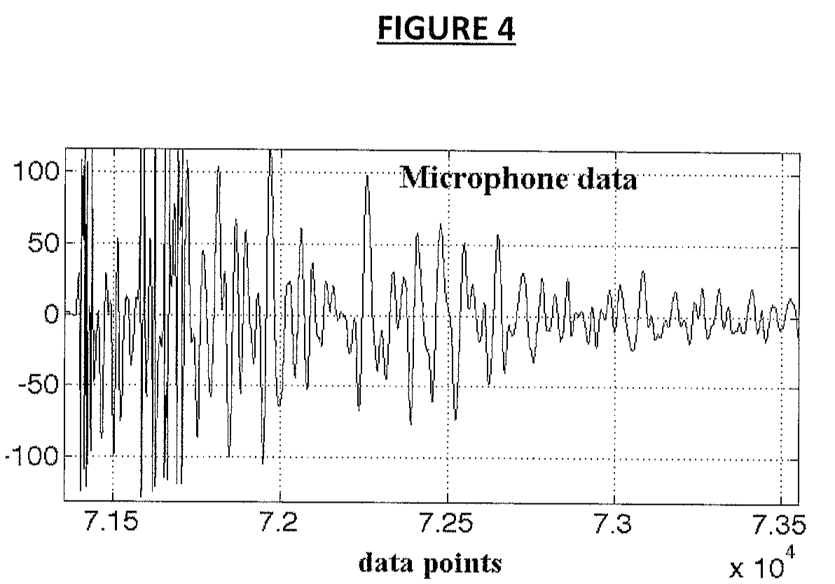

Referring now to FIG. 4, a sample graph illustrating the impulse response on a microphone corresponding to a tap event on a surface, according to at least one aspect of the invention. FIG. 4, indicates that a clear impulse response on a microphone may be found to correspond with a tap.

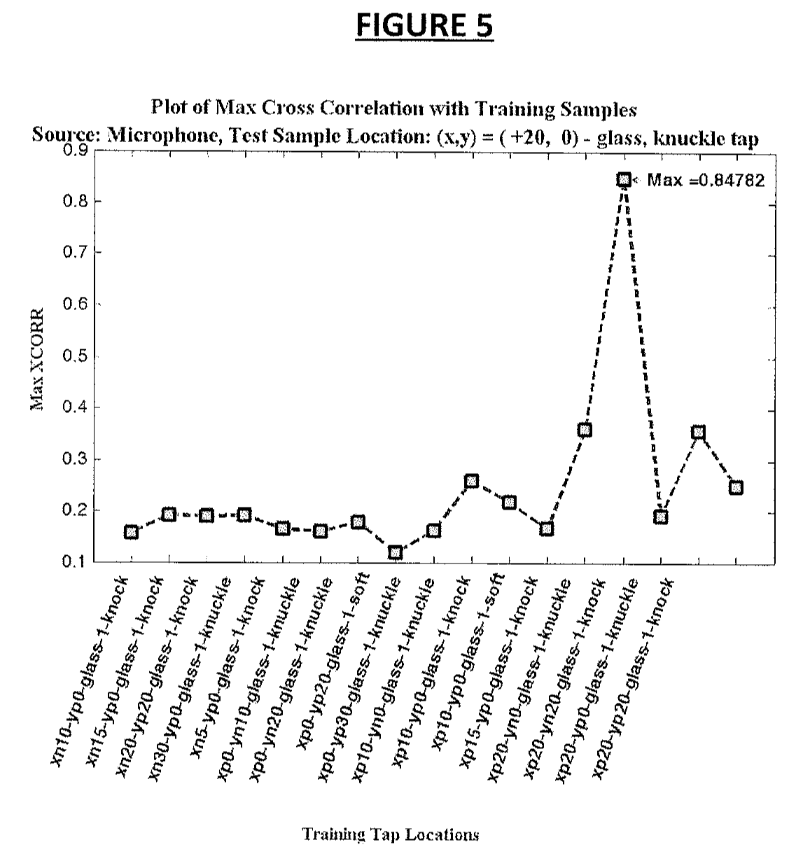

Referring now to FIG. 5, a sample graph illustrating the point of maximum cross-correlation values received by a microphone with a tap 20 cm away from the device, compared to template taps at various locations, according to at least one aspect of the invention. The numbers in brackets correspond to (x,y) coordinates. The results from FIG. 5 indicated that there may be high enough resolution on the microphone to differentiate taps at different tap locations, even in the presence of background acoustic and various levels of Gaussian noise.

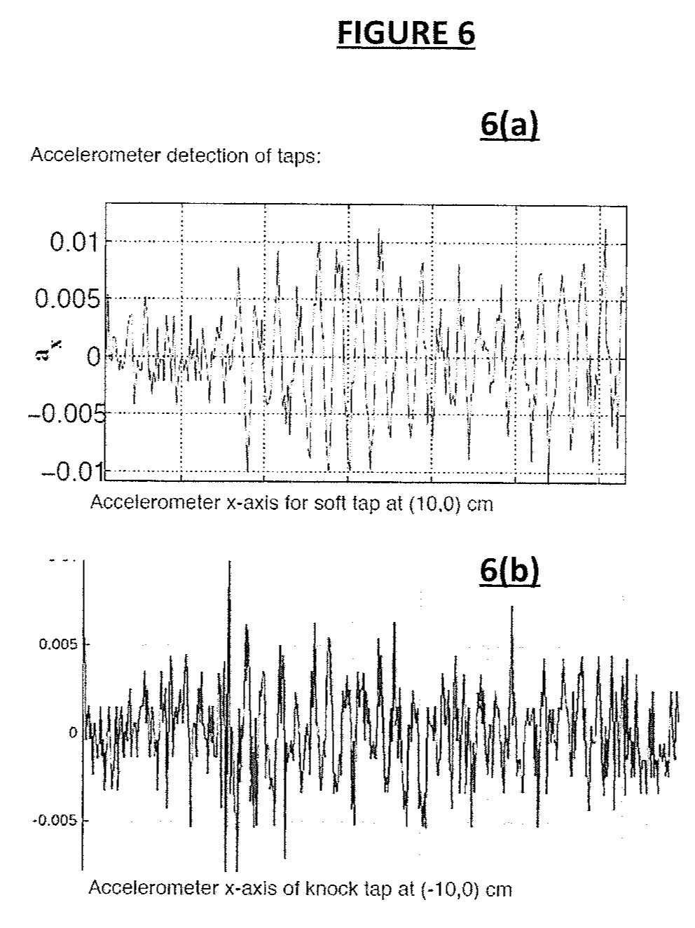

Referring now to FIGS. 6 (a) and (b), sample graphs illustrating the impulse response on a accelerometer in the x-axis to a tap event on a surface, (a) corresponding to a soft tap, and (b) corresponding to a knock tap, according to at least one aspect of the invention. The results indicated that an accelerometer in the x-axis may only provide a weak response.

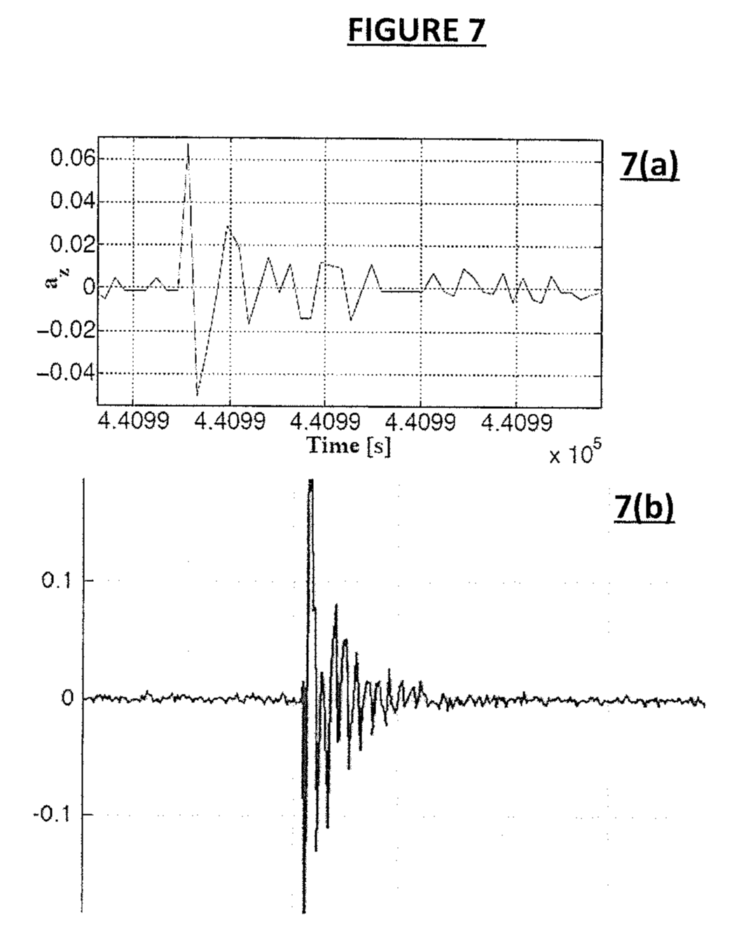

Referring now to FIGS. 7 (a) and (b), sample graphs illustrating the impulse response on a accelerometer corresponding in the z-axis to a tap event on a surface, (a) corresponding to a soft tap, and (b) corresponding to a knock tap, according to at least one aspect of the invention. FIGS. 7 (a) and (b) both illustrate that there may be a clear impulse response detected by the accelerometer in the z-axis, with the knock tap being more prominent than the soft tap.

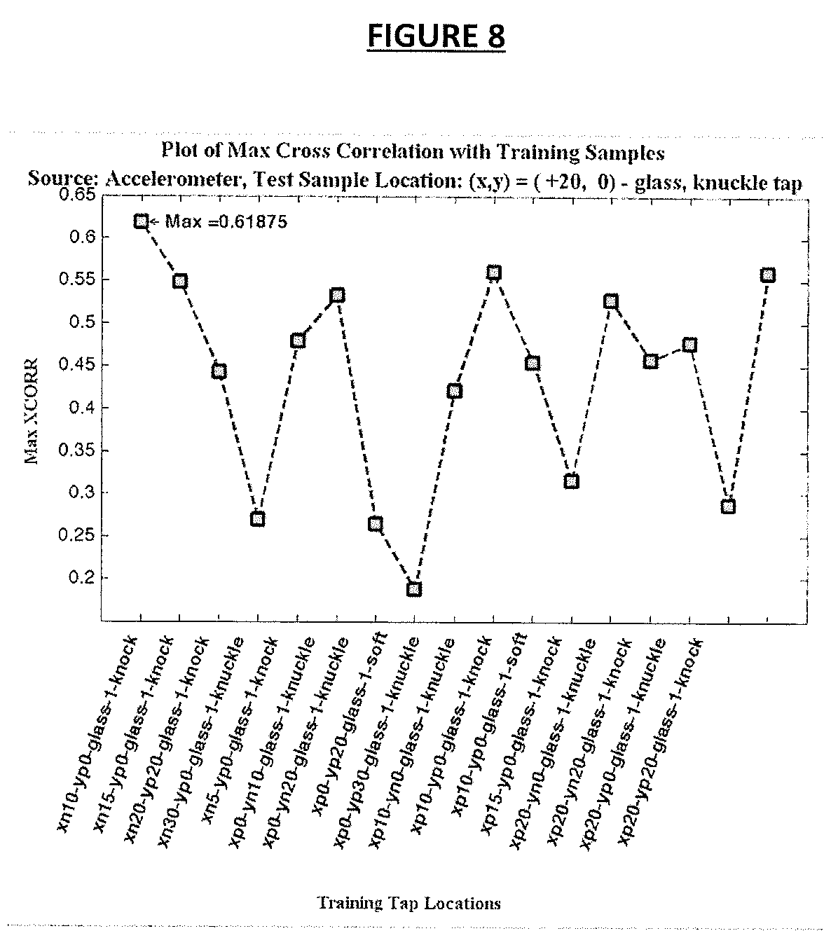

Referring now to FIG. 8, a sample graph illustrating the point of maximum cross-correlation values received by a accelerometer measuring in the z-axis with a knuckle tap on glass 20 cms away, compared to template taps at various locations, according to at least one aspect of the invention. FIG. 8 illustrates that determining the maximum cross-correlation in the z-axis may not provide a clear enough determination that two taps at the same location are associated.

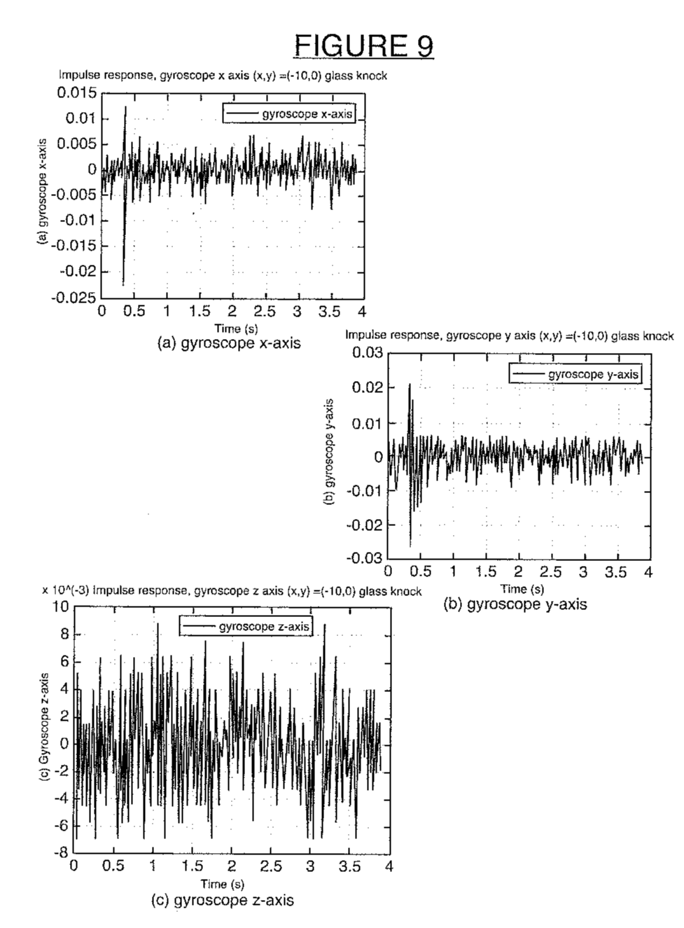

Referring now to FIG. 9 (a)-(c), sample graphs illustrating the impulse response on a gyroscope corresponding (a) in the x-axis, (b) in the y-axis, and (c) in the z-axis, according to at least one aspect of the invention. The results of FIGS. 9 (a)-(c) indicate that the gyroscope may not be enough to detect a tap event over the ambient noise. Accordingly, the gyroscope information may need to be used in conjunction with other sensory inputs.

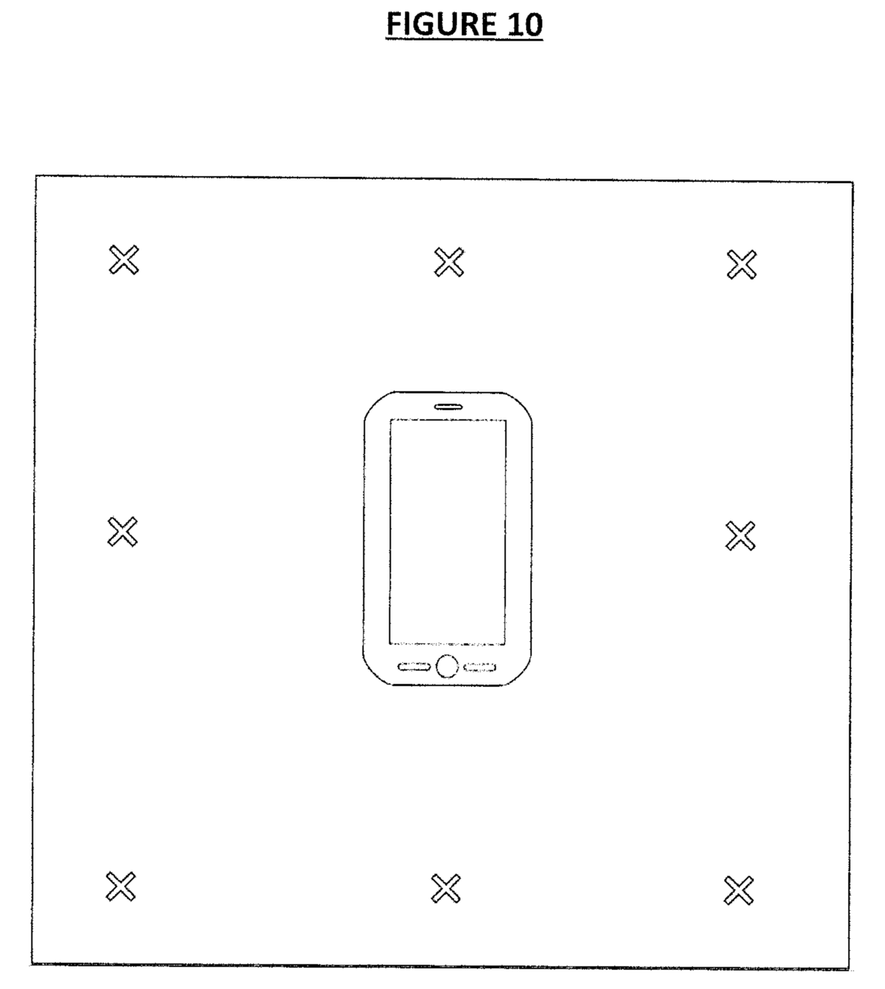

FIG. 10 is a top view perspective diagram of the device laid out on a surface, according to at least one aspect of the invention. The surface may be any surface which may be suitable for tap detection. In other embodiments of the invention, any surface that transmits enough sensory information may be used in conjunction with this system.

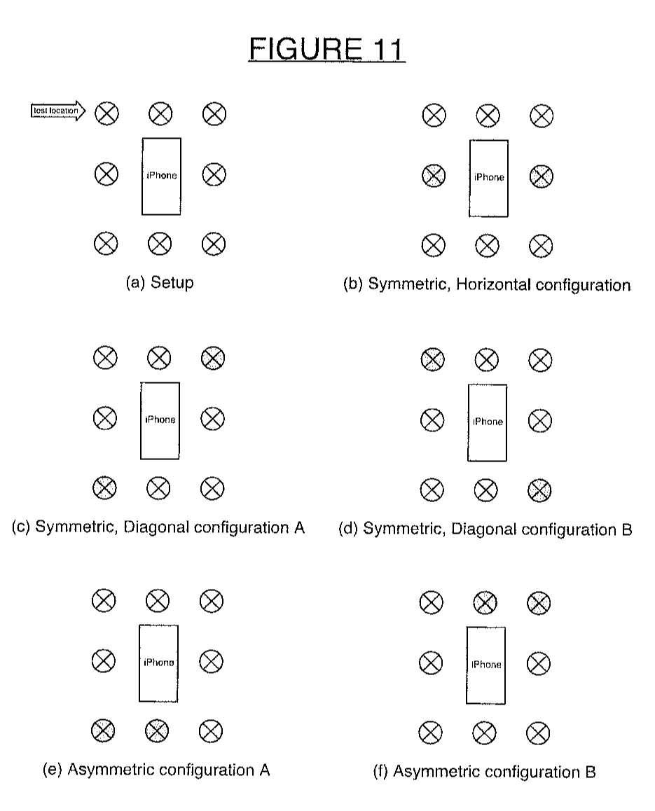

FIG. 11 (a)-(f) illustrate sample configurations for conducting tests on the system using two template points, according to at least one aspect of the invention.

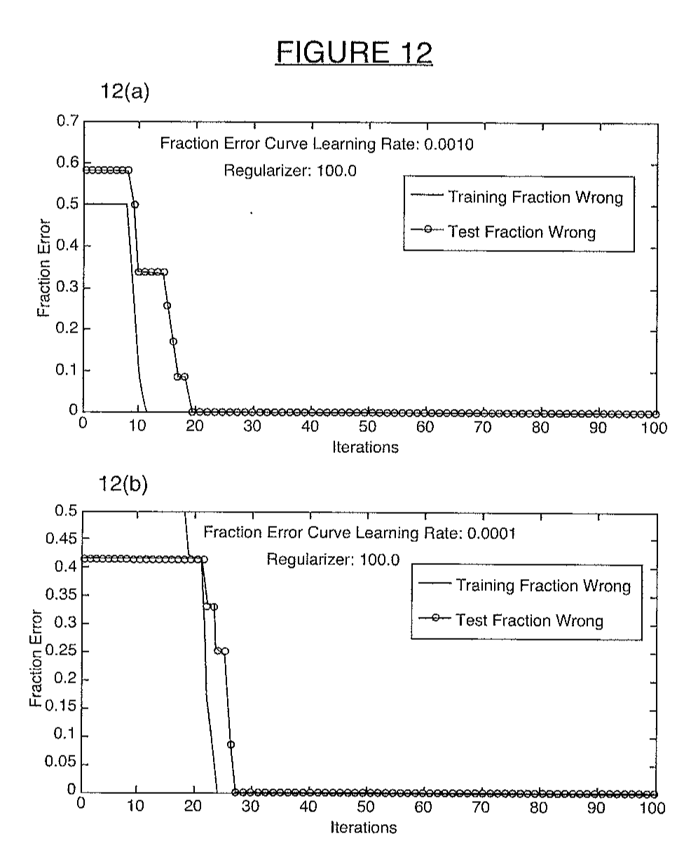

FIGS. 12 (a) and (b) are sample graphs illustrating error rates where a number of taps were classified to a number of different templates, in an embodiment of the invention. The learning rate, as indicated as 0.0010 in (a) and 0.0001 in (b). In this embodiment of the invention, the learning rate represents the rate at which the weight parameters of a logistic regression update at each iteration. If the learning rate is raised, then the logistic regression optimization converges faster, but there is the risk of not reaching a stable optimum. If the learning rate is lowered, then the logistic regression will take a longer time to converge, but can reach a more stable optimum because of the small steps. An approach to fine tuning the learning rate involves starting with a larger learning rate, and decreasing the rate as iterations converge near an optimum region.

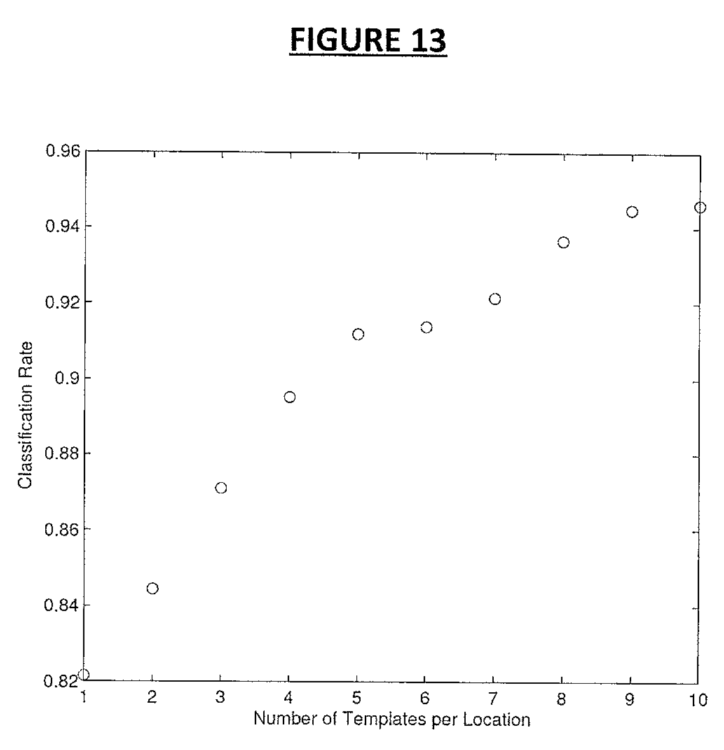

Referring now to FIG. 13, a sample graph comparing the classification rate of success to the number of templates per tap location, according to at least one embodiment of the invention. FIG. 13 indicates that there is a correlation between the number of templates taken per tap location and how accurately the system classified the taps as being from a particular tap location.

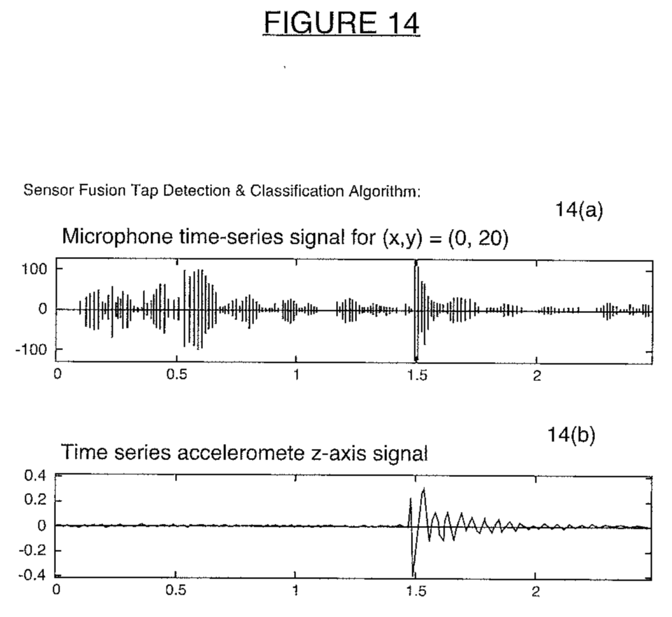

Referring now to FIGS. 14. (a) and (b) are sample graphs illustrating the impulse responses from (a) a microphone, and (b) an accelerometer in the z-axis, according to at least one aspect of the invention. The graphs indicate that there using the accelerometer in combination with the microphone to detect taps may provide better tap detection and classification.

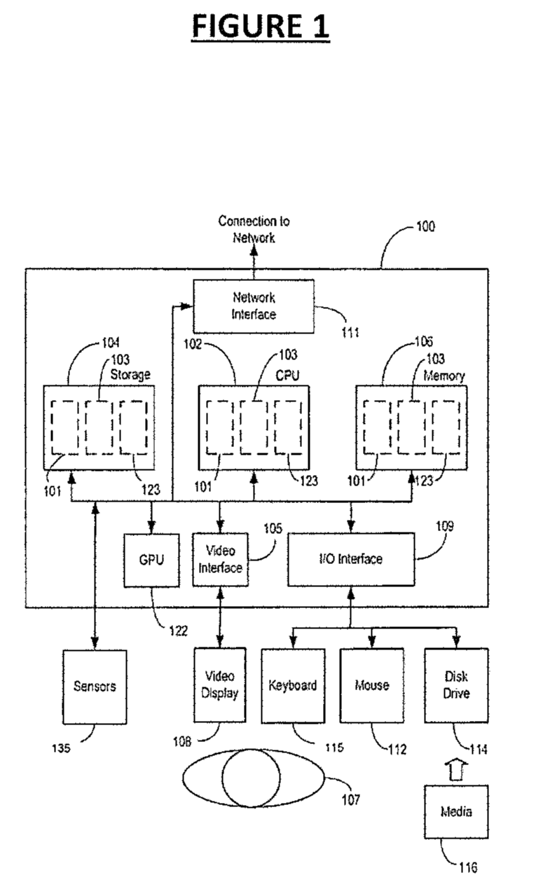

The present system and method may be practiced in various embodiments. A suitably configured computer device, and associated communications networks, devices, software and firmware may provide a platform for enabling one or more embodiments as described above, By way of example, FIG. 1 shows a generic computer device 100 that may include a central processing unit (“CPU”) 102 connected to a storage unit 104 and to a random access memory 106. The CPU 102 may process an operating system 101, application program 103, and data 123. The operating system 101, application program 103, and data 123 may be stored in storage unit 104 and loaded into memory 106, as may be required. Computer device 100 may further include a graphics processing unit (GPU) 122 which is operatively connected to CPU 102 and to memory 106 to offload intensive image processing calculations from CPU 102 and run these calculations in parallel with CPU 102. An operator 107 may interact with the computer device 100 using a video display 108 connected by a video interface 105, and various input/output devices such as a keyboard 115, mouse 112, and disk drive or solid state drive 114 connected by an I/O interface 109. In known manner, the mouse 112 may be configured to control movement of a cursor in the video display 108, and to operate various graphical user interface (GUI) controls appearing in the video display 108 with a mouse button. The disk drive or solid state drive 114 may be configured to accept computer readable media 116. The computer device 100 may form part of a network via a network interface 111, allowing the computer device 100 to communicate with other suitably configured data processing systems (not shown). One or more different types of sensors 135 may be used to receive input from various sources.

The present system and method may be practiced on virtually any manner of computer device including a desktop computer, laptop computer, tablet computer or wireless handheld. The present system and method may also be implemented as a computer-readable/useable medium that includes computer program code to enable one or more computer devices to implement each of the various process steps in a method in accordance with the present invention. In case of more than computer devices performing the entire operation, the computer devices are networked to distribute the various steps of the operation. It is understood that the terms computer-readable medium or computer useable medium comprises one or more of any type of physical embodiment of the program code. In particular, the computer-readable/useable medium can comprise program code embodied on one or more portable storage articles of manufacture (e.g. an optical disc, a magnetic disk, a tape, etc.), on one or more data storage portioned of a computing device, such as memory associated with a computer and/or a storage system.

The mobile application of the present invention may be implemented as a web service, where the mobile device includes a link for accessing the web service, rather than a native application.

The functionality described may be implemented to any mobile platform, including the iOS™ platform, ANDROID™, WINDOWS™ or BLADKBERRY™.

It will be appreciated by those skilled in the art that other variations of the embodiments described herein may also be practiced without departing from the scope of the invention. Other modifications are therefore possible.

In further aspects, the disclosure provides systems, devices, methods, and computer programming products, including non-transient machine-readable instruction sets, for use in implementing such methods and enabling the functionality described previously.

Although the disclosure has been described and illustrated in exemplary forms with a certain degree of particularity, it is noted that the description and illustrations have been made by way of example only. Numerous changes in the details of construction and combination and arrangement of parts and steps may be made. Accordingly, such changes are intended to be included in the invention, the scope of which is defined by the claims.

Except to the extent explicitly stated or inherent within the processes described, including any optional steps or components thereof, no required order, sequence, or combination is intended or implied. As will be will be understood by those skilled in the relevant arts, with respect to both processes and any systems, devices, etc., described herein, a wide range of variations is possible, and even advantageous, in various circumstances, without departing from the scope of the invention, which is to be limited only by the claims.

### Other Applications and Embodiments

In other embodiments of the invention, the system 200 may be configured to distinguish between tap events that occur between different limbs or different objects. For example, it is possible to distinguish between hands, knuckles, feet, fingernails, or various objects striking a surface, etc. as the temporal and spectral features of the different strikes would depend on the physical properties of the surface and the object.

In other embodiments of the invention, the system 200 may be configured to distinguish between “soft” tap events and “hard” tap events.

In other embodiments of the invention, the system 200 may be configured to distinguish between tap events on different parts of a device 202. For example, a tap event on the bezel would be different from a tap event on the rear.

In other embodiments of the invention, the system 200 may be configured to associate taps in sequence to be “double taps” or “multiple taps”, similar to double clicks by a mouse on a computer system.

In other embodiments of the invention, the system 200 may be used on a surface 204, the surface 204 having tactile elements such as “bumps” to segment the surface into different areas for tapping.

In other embodiments of the invention, the surface 204 may be instead be a wall, a floor or a ceiling.

In other embodiments of the invention, the surface 204 may comprise sound-conductive qualities at different locations to help the system 200 differentiate between the various components of the surface 204.

Such a tap detection and classification system that can detect taps on an adjacent surface may be used to build many new human computer interaction platforms including the ones outlined below:

Better Gaming Platforms:

The system may enable a larger surface through which a user can control their game movements making it easier to interact and play using their smartphones. One example application could be if a user is playing a racing game, he or she can map four different tap locations to the actions of acceleration, break, turning left and right. Moreover, tap detection capability could enable an easier way to use a smartphone to play any game with multiple players. One example of such a multiplayer extension could be a ping pong game played using one device, where the screen is projected onto a television or projector through airplay. When the phone is placed on a table, using extended touch, tap locations close to different players can be mapped to locations on the game's ping-pong table. The players then tap on the table near them to hit the ball. A third example of gaming application could be a virtual poker manager or dealer using tap detection. The device could be placed anywhere on the table, and each player makes a bet by tapping at a location close to them. An application can be built to track each tap location per player, and manage the bets and progression of the poker game for all the players. Tap detection creates the possibility of developing many creative applications by extending the area through which users may control the device.

Augmented Reality with Tap Detection:

Tap detection may be used to develop innovative augmented reality applications with more tactile interactions. One example of such an application is to use tap detection to interact with toys, whether they are physical or virtual. For example, one could think of a toy character whose role and/or movement can be controller or modified in the game setting using tap detection system provided by tap detection. Assume the player has set up x number of taps for different controls. The player could tap on location A to make the toy/character perform different actions such as jump, bend and so on, where single or double taps at location A could perform variable actions. The player can tap on tap location B to make the character walk towards location B. The player can tap on location C to control environment change in the game application or generate background affects or acoustics. One can think many such other interactive effects added to a toy or game platform and experience that is trigger by a tap detection interface. Introducing tap detection in this way can enhance the augmented reality element of the toy game platform and lead to a more tactile and immersive experience.

This idea of augmented reality with tap detection can also be applied to board games or puzzles, or any types of control scenario. Another example of a board game could be a physical maze game, where a car or a character tries to win by moving through the maze and exiting. The human player can place their smartphone on a designated spot on the game board, making the entire surface tap sensitive. The human player can then make it easier or harder for the moving car or character to exit the maze by either tapping on different locations within the maze, which gets detected by tap detection technology and communicated to the moving character/car, thus enhancing the interactivity between the physical character and the human player.

Virtual Musical Instruments:

Similar to the gaming application, having a larger tactile surface area as the input-interface to portable devices, one could development various virtual musical instruments applications that can provide a more natural user experience. One example of a virtual instrument using tap detection is a Piano application where seven different tap locations on a neighboring table could be registered as different musical notes. The user can tap one of these notes (tap locations defined by the user) to simulate playing the octave keys. The detection could be extended to include more keys to develop a virtual keyboard the user can play anywhere by just tapping on the surface their smartphone is placed on. One could also imagine many similar applications where more instruments could be added, such as drums, with addition of multiple players who can play the instruments simultaneously on the same surface.

Page Navigation from a Distance:

Tap detection can be applied to develop applications that greatly simplifies the task of presenting a portable document format (PDF) document, or Keynote presentations from a smartphone or tablet. If the presenter places the device on a table, which is being used for streaming the presentation, the entire table can become an input interface using tap detection by mapping different tap locations to browsing the presentation document. Therefore, the presenter or anyone else sitting around the table could move forward or backward in the document by just tapping on the table near them which can be detected and used to facilitate navigation through the pages.

There are many other scenarios such as while the user is cooking or cleaning, where tap detection applied to browsing or page-navigation may be extremely useful. One such example is a cooking application where it is not desirable to touch an iPhone or iPad's touch screen with food covered hands. Thus looking at the next page or next instruction by tapping near the phone would lead to a better user experience while keeping the iPhone or iPad hands free.

Multiple User Defined Activities Launcher:

Tap detection may be integrated into the operating system of any portable device where the user can define their own actions corresponding to different tap locations. The integration would allow developers to write applications where the user can snooze alarm clocks, send emails or texts, receive or initiate phone calls by tapping on different locations on the neighboring surface of the smartphone.

Interactive Furniture & Smart Homes:

Using tap detection, interfaces can be developed that extend the input interface beyond the touch screen into the surface the device is placed on, and perform various action such as the ones described in the previous examples. The integration could lead to developing smart or modern furniture or appliances that are tap detection compliant. For example, a designer could design a patterned furniture such as a bed-side table or coffee table where tapping on different patterns, colours or textured area launch different actions on the smartphone, actions that are defined by the user, some examples of which were discussed in last few paragraphs. A patterned coffee-table for example could be used to play the virtual poker game discussed earlier using tap detection. It could also be used to play any types of board games or navigate your digital devices as an alternative to having touch screen or mouse interaction. One could also have tap detection activated functionality integrated into appliances such as the fridge, kitchen counter, theater control system in one's home. One could place a device on a designated area on the appliance, and tap on different locations to control the appliance's settings. In a restaurants, the tables, menus or billboard can integrate tap detection to inform the customer about the menu, latest specials or even to order or call waiters, which the customer can take advantage of by just placing their devices on that table, menu or the billboard.

Workout Assistance/Monitor:

Tap detection technology can be used to detect not just hand taps, but also foot step locations, dance taps, or jump locations on the floor. One can use this detection to develop a work-out instruction application, similar to that of Dance Dance Revolution by Konami, but without the use of any external sensor-loaded mat, and making use of only the built-in sensors available in smartphones.

Keyboard Application & Security:

This technology could potentially be applied to infer key-strokes from a physical keyboard that is placed on the same surface, thus introducing a new topic in mobile security exploration. Since users often leave their smartphones on the desk while working, one can train tap detection technology to recognize vibrations caused by key-strokes at a distant keyboard, and combine it with language models and machine learning to infer what the user is typing. This could be used to launch security attacks on portable devices. Tap detection could also be combined with natural language processing and machine learning to develop virtual keyboards.

Tap detection could be applied to provide alternative, inexpensive and convenient interface for many workplace applications such as the hospital. Moreover, it could be a more intuitive interface for children or people with disabilities where they can tap on different objects or marks on their table to interact with a digital device or to participate in class. Since tap detection may provide a more tactile experience encompassing a larger surface area, it may be of particular assistance to individuals with physical disabilities.

What is claimed is:

1. A computer-related system for detecting one or more taps on a surface or on a device, the system comprising:
(a) at least one module configured to detect one or more taps by receiving signals from one or more sensors;
(b) at least one module configured to process signals related to the one or more taps to determine a set of temporal and spatial signal characteristics;
(c) at least one module configured to map signals related to the one or more taps to associate the one or more taps with one or more application controls; and
(d) at least one module configured to classify signals related to the one or more taps to determine whether the one or more taps are associated with the one or more application controls.

2. The system of claim 1, wherein the system further comprises at least one module configured to reduce noise.

3. The system of claim 1, wherein the at least one module configured to map signals related to the one or more taps to associate the taps with one or more application controls uses a plurality of taps to associate the taps with the one or more application controls.

4. The system of claim 3, wherein the at least one module configured to map signals related to the one or more taps to associate the taps with one or more application controls combines a plurality of taps to develop a single representative template for associating taps with the one or more application controls.

5. The system of claim 1, wherein the at least one module configured to classify signals is configured to, upon detecting one or more taps that do not match any of the one or more application controls, maps the one or more taps as one or more new, unassociated taps.

6. The system of claim 1, wherein the at least one module configured to process signals related to the one or more taps is configured to distinguish taps by determining that the difference between the taps is at least one of (a) location of tap proximate to the surface, (b) characteristics of the part of the surface being tapped, (c) different implements striking the surface or (d) amount of force applied on the surface.

7. The system of claim 1, wherein the surface has been marked to delineate different sections of the surface for use with the system.

8. The system of claim 1, wherein the system is configured for use with a mobile device, a laptop, a home appliance, tablet computer, or a desktop computer.

9. The system of claim 1, wherein the sensors include at least one of (a) microphone, (b) accelerometer, (c) gyroscope, (d) location sensor or (e) proximity sensors.

10. A computer-related method for detecting one or more taps on a surface or on a device, the method comprising:
(a) detecting one or more taps by receiving signals from one or more sensors;
(b) processing signals related to the one or more taps to determine a set of temporal and spatial signal characteristics;
(c) mapping signals related to the one or more taps to associate the one or more taps with one or more application controls; and
(d) classifying signals related to the one or more taps to determine whether the one is or more taps are associated with the one or more application controls.

11. The method of claim 10, wherein the method further comprises processing signals to reduce noise.

12. The method of claim 10, wherein mapping signals related to the one or more taps to associate the taps with one or more application controls comprises using a plurality of taps to associate the taps with the one or more application controls.

13. The method of claim 12, wherein mapping signals related to the one or more taps to associate the taps with one or more application controls comprises combining a plurality of taps to develop a single representative template for associating taps with the one or more application controls.

14. The method of claim 10, wherein classifying signals comprises, upon detecting one or more taps that do not match any of the one or more application controls, mapping the one or more taps as one or more new, unassociated taps.

15. The method of claim 10, wherein processing signals related to the one or more taps comprises distinguishing taps by determining that the difference between the taps is at least one of (a) location of tap proximate to the surface, (b) characteristics of the part of the surface being tapped, (c) different implements striking the surface or (d) amount of force applied on the surface.

16. The method of claim 10, wherein the surface has been marked to delineate different sections of the surface for use with the method.

17. The method of claim 10, wherein the method is used with a mobile device, a laptop, a home appliance, tablet computer, or a desktop computer.

18. The method of claim 10, wherein the sensors include at least one of (a) microphone, (b) accelerometer, (c) gyroscope, (d) location sensor or (e) proximity sensors.

19. A non-transitory computer readable medium with instructions encoded thereon to configure a processor to detect one or more taps on a surface or on a device, wherein the processor is configured to detect one or more taps by receiving signals from one or more sensors; process signals related to the one or more taps to determine a set of temporal and spatial signal characteristics; map signals related to the one or more taps to associate the taps with one or more application controls; and classify signals related to the one or more taps to determine whether the taps are associated with the one or more application controls.

20. The computer readable medium of claim 19, wherein the sensors include at least one of (a) microphone, (b) accelerometer, (c) gyroscope, (d) location sensor or (e) proximity sensors.
